(19) United States
(12) Patent Application Publication
(10) Pub. No.: US 2007/0003727 A1
(43) Pub. Date: Jan. 4, 2007

(54) Soft magnet structure

(76) Inventors: Chen-Liang Fan Chiang, Taipei (TW); Hung-Chih Wu, Taipei (TW)

Correspondence Address: BRUCE H. TROXELL, SUITE 1404, 5205 LEESBURG PIKE, FALLS CHURCH, VA, 22041, US

(21) Appl. No.: 11/171,392

(22) Filed: Jul. 1, 2005

(51) Int. Cl. G09F 3/00; B32B 3/30

(52) U.S. Cl. 428/43; 428/167

(57) ABSTRACT

A soft magnet structure including a plane blank of soft magnet. The plane blank is embossed with a tissue of densely arranged stripes. The stripes extend in the same direction and are arranged on at least one surface of the plane blank, whereby when an external force or shear force is applied to the soft magnet along the stripes, the soft magnet can be torn apart in the direction of the stripes.

### BACKGROUND OF THE INVENTION

The present invention is related to an improved soft magnet structure which is embossed with a tissue of densely arranged stripes. The stripes extend in the same direction, whereby the soft magnet can be manually torn apart in the direction of the stripes without using any tool.

A soft magnet is generally a complex sheet or block material made from mixture of magnetizable powder, such as ferric oxide powder, and rubber or plastic. The material is at least once magnetized in such a manner that pulse current passes through a magnetic conducting disc with different magnetizing divisions. The magnetic conducting disc serves to induce magnetic poles with different polarities on the surface of the material. Accordingly, a soft magnet with flexibility and magnetic attraction is achieved for attracting a magnetically attractable article (such as an iron material). The soft magnet can be used to make decorative magnetic block (sheet), magnetic clip, magnetic paper holder or other locating members for fixing papers. Recently, a very thin soft magnetic sheet has been developed for wider application.

In the manufacturing procedure, the soft magnet must be first molded and magnetized and then cut into a product.

The conventional custom soft magnet is divided into pieces by cutting. The thin sheet-type soft magnet must be cut by means of a cutting tool. Especially, in the case that it is necessary to cut the soft magnet by a long length, a precise measurement and locating platform are required for the cutting operation. In a modularized soft magnet production line, the above measurement and cutting operation complicate the manufacturing procedure and increase the manufacturing cost. Therefore, it is tried by the applicant to simplify the texture and structure of the soft magnet to facilitate the cutting operation.

### SUMMARY OF THE INVENTION

It is therefore a primary object of the present invention to provide an improved soft magnet structure including a plane blank of soft magnet. The plane blank is embossed with a tissue of densely arranged stripes. The stripes extend in the same direction and are arranged on at least one surface of the plane blank. When an external force or shear force is applied to the soft magnet along the stripes, the soft magnet can be easily torn apart in the direction of the stripes.

The present invention can be best understood through the following description and accompanying drawings wherein:

### BRIEF DESCRIPTION OF THE DRAWINGS

FIG. 1 is a perspective view of the present invention;

FIG. 2A shows that the plane blank is embossed with longitudinal stripes by an embossing roller;

FIG. 2B shows that the plane blank is embossed with transverse stripes by an embossing roller;

FIG. 3A shows a pattern of the embossed stripes of the soft magnet of the present invention;

FIG. 3B shows another pattern of the embossed stripes of the soft magnet of the present invention;

FIG. 3C shows a dotted pattern of the soft magnet of the present invention;

FIG. 4 shows that the soft magnet embossed with the stripes is torn apart; and

FIG. 5 is a sectional view showing the stripes of the soft magnet of the present invention.

### DETAILED DESCRIPTION OF THE PREFERRED EMBODIMENTS

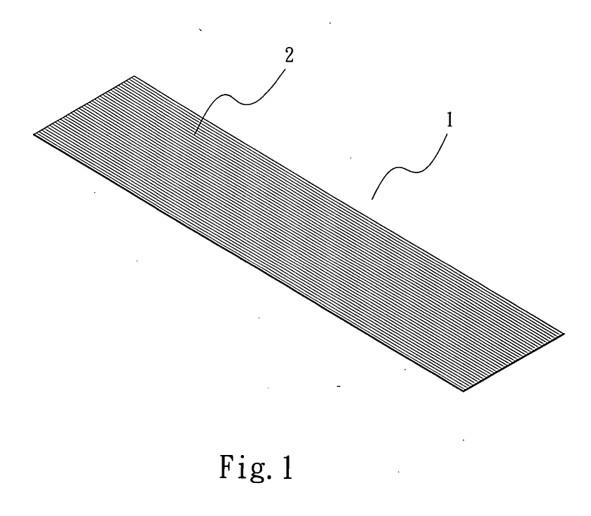

Please refer to FIG. 1. The plane blank 1 of the soft magnet of the present invention is embossed with a tissue 2 of densely arranged stripes. The stripes extend in the same direction at equal intervals or unequal intervals. In this embodiment, the embossed stripe tissue 2 has multiple channels with a certain depth. The channels are formed on at least one surface of the plane blank 1.

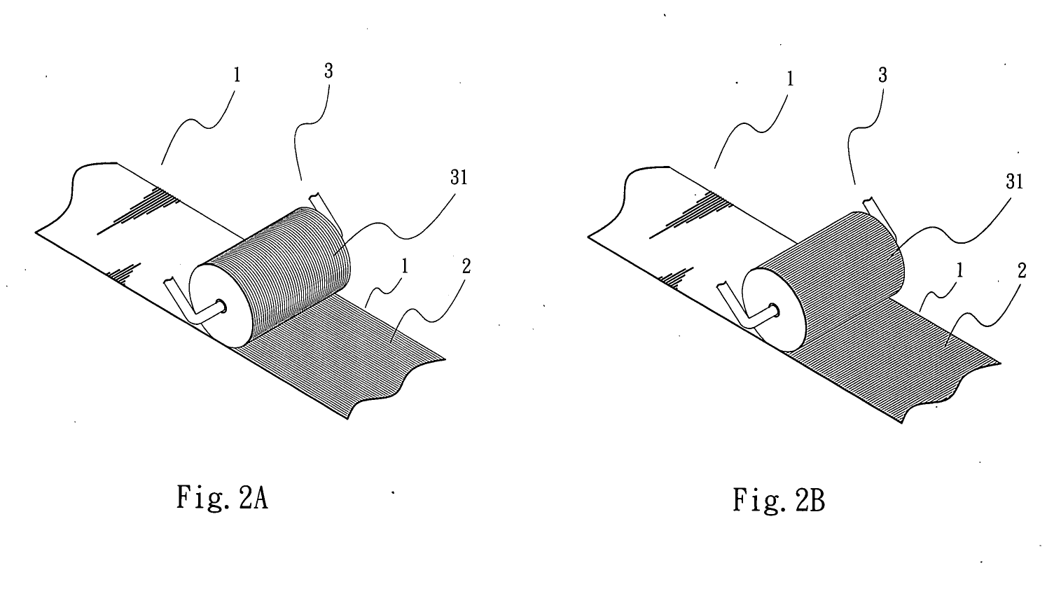

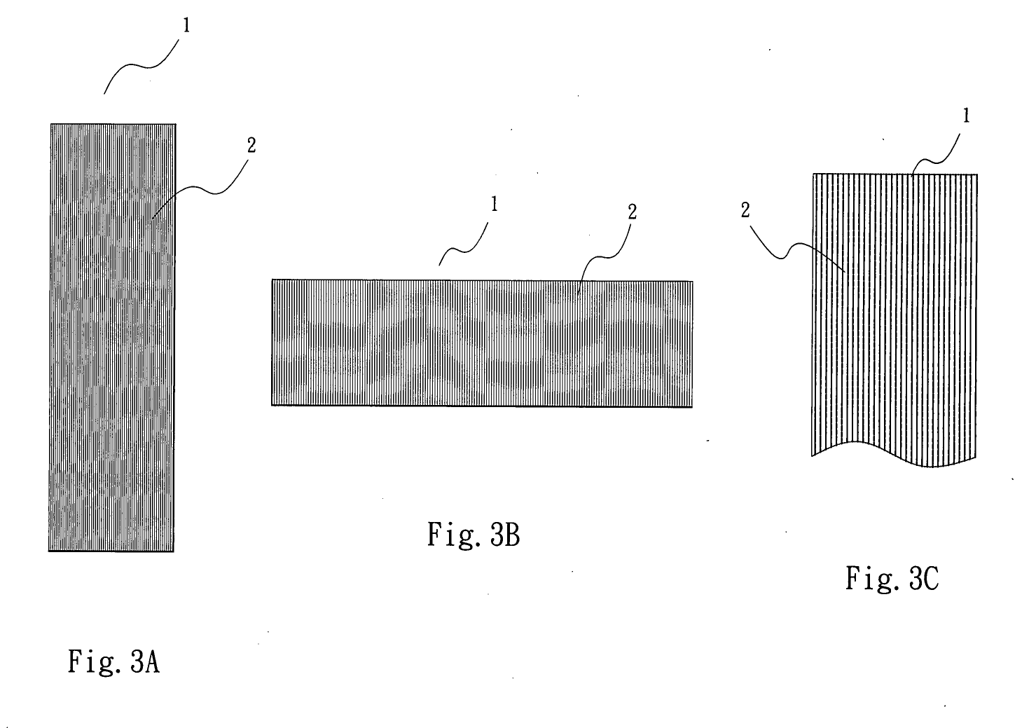

FIGS. 2A and 2B show an embossing machine for embossing the soft magnet. The circumferential face of a roller 3 is formed with densely arranged stripe-like blades 31 extending in the same direction. When the plane blank 1 of the soft magnet passes through the roller 3, the roller 3 embosses the plane blank with the stripe tissue 2. The arrangement pattern of the stripe tissue 2 is determined by the pattern of the blades 31. After embossed, the plane blank 1 is formed with longitudinally arranged stripe tissue (FIG. 3A), transversely arranged stripe tissue (FIG. 3B), dotted tissue (FIG. 3C) or the like.

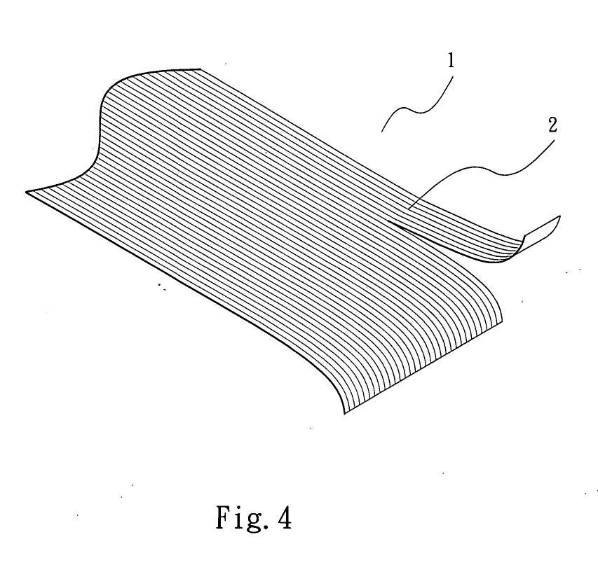

Referring to FIG. 4, the soft magnet with the embossed stripe tissue 2 can be easily manually torn apart in the direction of the stripe tissue 2. Alternatively, the soft magnet with the embossed stripe tissue 2 can be directly torn apart by a manufacturer with an auxiliary tool (such as a ruler or a blade) in the direction of the stripe tissue 2 according to necessary size and shape. Therefore, it is unnecessary to previously measure the soft magnet before cutting the soft magnet. In addition, the soft magnet can be torn into pieces without using any cutting tool.

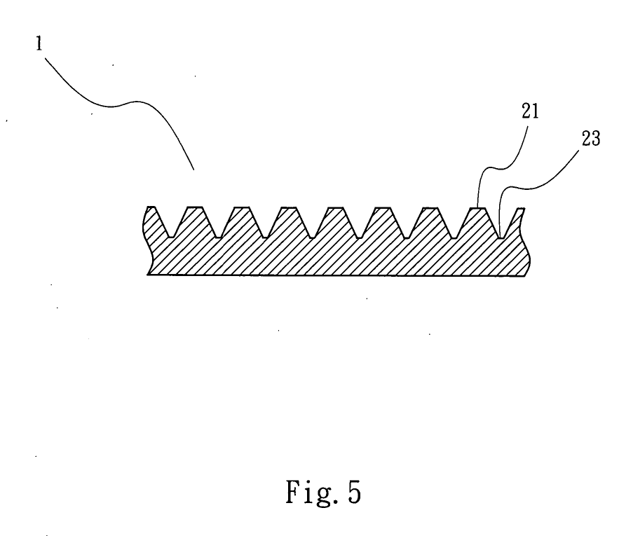

FIG. 5 is an enlarged sectional view of the soft magnet. FIG. 5 shows that the embossed stripe tissue 2 is formed as a saw-tooth structure on the plane blank 1. The embossed stripe tissue 2 includes ridge sections 21 and trough sections 23 between the adjacent ridge sections 21. The thickness of the plane blank 1 is thinned at the trough sections 23, whereby the soft magnet can be torn apart by external force or shear force.

The above embodiments are only used to illustrate the present invention, not intended to limit the scope thereof. Many modifications of the above embodiments can be made without departing from the spirit of the present invention.

What is claimed is:

1. A soft magnet structure comprising a plane blank of soft magnet, the plane blank being embossed with a tissue of densely arranged stripes, the stripes extending in the same direction and being arranged on at least one surface of the plane blank, whereby when an external force or shear force is applied to the soft magnet along the stripes, the soft magnet can be torn apart in the direction of the stripes.

2. The soft magnet structure as claimed in claim 1, wherein the stripes are longitudinally arranged or transversely arranged on the plane blank.

3. The soft magnet structure as claimed in claim 1, wherein the plane blank is embossed with a dotted tissue.

4. The soft magnet structure as claimed in claim 2, wherein the plane blank is embossed with a dotted tissue.

5. The soft magnet structure as claimed in claim 1, wherein the embossed stripe tissue of the plane blank is like a saw-tooth structure.

6. The soft magnet structure as claimed in claim 2, wherein the embossed stripe tissue of the plane blank is like a saw-tooth structure.

7. The soft magnet structure as claimed in claim 5, wherein the embossed stripe tissue of the plan blank includes ridge sections and trough sections between the adjacent ridge sections.

8. The soft magnet structure as claimed in claim 6, wherein the embossed stripe tissue of the plan blank includes ridge sections and trough sections between the adjacent ridge sections.

9. The soft magnet structure as claimed in claim 1, wherein the stripes of the tissue are arranged at equal intervals.

10. The soft magnet structure as claimed in claim 2, wherein the stripes of the tissue are arranged at equal intervals.

11. The soft magnet structure as claimed in claim 3, wherein the dots of the tissue stripes are arranged at equal intervals.

12. The soft magnet structure as claimed in claim 4, wherein the dots of the tissue stripes are arranged at equal intervals.

13. The soft magnet structure as claimed in claim 5, wherein the stripes of the tissue are arranged at equal intervals.

14. The soft magnet structure as claimed in claim 6, wherein the stripes of the tissue are arranged at equal intervals.
